(19) United States
(12) Patent Application Publication
(10) Pub. No.: US 2014/0340680 A1
(43) Pub. Date: Nov. 20, 2014

(54) APPARATUS AND METHOD FOR MOBILE DEVICE CAMERA TESTING

(71) Applicant: Labsphere, Inc., North Sutton, NH (US)

(72) Inventors: Richard Montminy, North Sutton, NH (US); Dan Scharpf, North Sutton, NH (US); Jonathan Scheuch, North Sutton, NH (US); Chris Durell, North Sutton, NH (US)

(73) Assignee: Labsphere, Inc., North Sutton, NH (US)

(21) Appl. No.: 14/361,747

(22) PCT Filed: Nov. 30, 2012
(86) PCT No.: PCT/US2012/067420

§ 371 Date: May 30, 2014

Related U.S. Application Data
(60) Provisional application No. 61/564,958, filed on Nov. 30, 2011.

(51) Int. Cl. G03B 43/00; H04N 17/00

(52) U.S. Cl. CPC G03B 43/00; H04N 17/002
USPC 356/326; 356/300

(57) ABSTRACT

A mobile device testing system with a sphere assembly is disclosed. The sphere assembly is a source integrating sphere and a test integrating sphere connected by an optical channel. A source illuminates the source integrating sphere with electromagnetic radiation of a known spectrum of wavelengths, usually light. The electromagnetic radiation travels to the test integration sphere through the optical channel. A first filter assembly and/or a second filter assembly rotate a plurality of filters into the optical channel to change the spectral distribution of wavelengths of the electromagnetic radiation in the test integrating sphere. A mobile device is mounted to the test integrating sphere and the spectral distribution of an image acquired by the mobile device is compared to a spectral measurement from a spectrometer.

### CROSS REFERENCE TO RELATED APPLICATIONS

The present application hereby claims priority under 35 U.S.C. §119(e) to Provisional U.S. Application No. 61/564,958 filed Nov. 30, 2011, entitled “Apparatus and Method for Mobile Device Camera Testing.”

### SUMMARY

In one embodiment, a sphere assembly may include a source integrating sphere, a test integrating sphere and a first filter assembly. The source integrating sphere may include a source shell, a source port coupled to the source shell, a source coupled to the source port, and a source frame port coupled to the source shell. The test integrating sphere may include a test shell, a mount plate coupled to the test shell, a fixture plate coupled to the mount plate, a spectrometer port coupled to the test shell, a spectrometer coupled to the spectrometer port, and a test frame port coupled to the test shell. The first filter assembly may include a filter frame, a communication connector coupled to the filter frame, a manual control pad coupled to the filter frame, a wheel coupled to the filter frame including a plurality of filters, the wheel aligns one of the plurality of filters with the optical channel, wherein when a command signal is sent to the first filter assembly, the wheel rotates to change the filter in an optical channel, the optical channel located between the source integrating sphere and the test integrating sphere.

In another embodiment, a method for testing a mobile device camera may include attaching a mobile device camera to the sphere assembly, illuminating the test integration sphere with electromagnetic radiation by illuminating the source integration sphere with the source, the electromagnetic radiation traveling through the optical channel, evaluating a spectral distribution of an image acquired by the camera, and comparing the spectral distribution to a spectral measurement from the spectrometer.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative in nature and not intended to limit the subject matter defined by the claims. The following detailed description of the illustrative embodiments can be understood when read in conjunction with the following drawings, where like structure is indicated with like reference numerals and in which:

FIG. 1 depicts a side elevation view of a sphere assembly according to one or more embodiments shown and described herein;

FIG. 2 depicts a top view of the sphere assembly according to one or more embodiments shown and described herein;

FIG. 3 an illustrative filter assembly according to one or more embodiments shown and described herein;

FIG. 4 depicts a cross-sectional view of the sphere assembly according to one or more embodiments shown and described herein;

FIG. 5 depicts a cross-sectional view of a test integrating sphere according to one or more embodiments shown and described herein; and

FIG. 6 depicts a mobile device camera testing system according to one or more embodiments shown and described herein.

### DETAILED DESCRIPTION

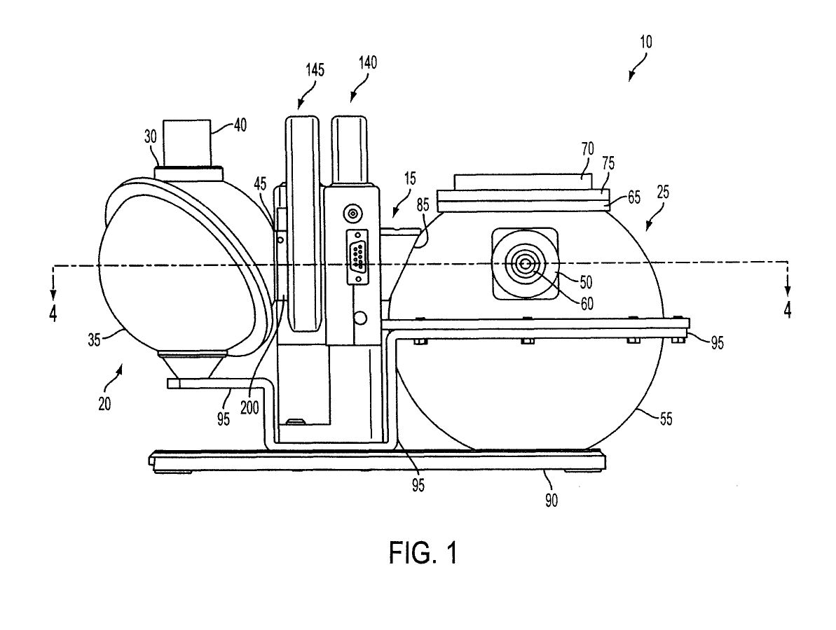

FIG. 1 generally depicts one embodiment of a mobile device testing system with a sphere assembly. The sphere assembly has two spheres; a source integrating sphere and a test integrating sphere connected by an optical channel. A source illuminates the source integrating sphere with electromagnetic radiation of a known spectrum of wavelengths and wavelength range, usually of the visible spectrum, i.e. light. The electromagnetic radiation travels to the test integration sphere through the optical channel. A first filter assembly and/or a second filter assembly rotate a plurality of filters into the optical channel to change the spectral distribution of wavelengths of the electromagnetic radiation in the test integrating sphere. A mobile device is mounted to the test integrating sphere and the spectral distribution of an image acquired by the mobile device is compared to a spectral measurement from a spectrometer. Various embodiments of the testing system and the operation of the testing system will be described in more detail herein.

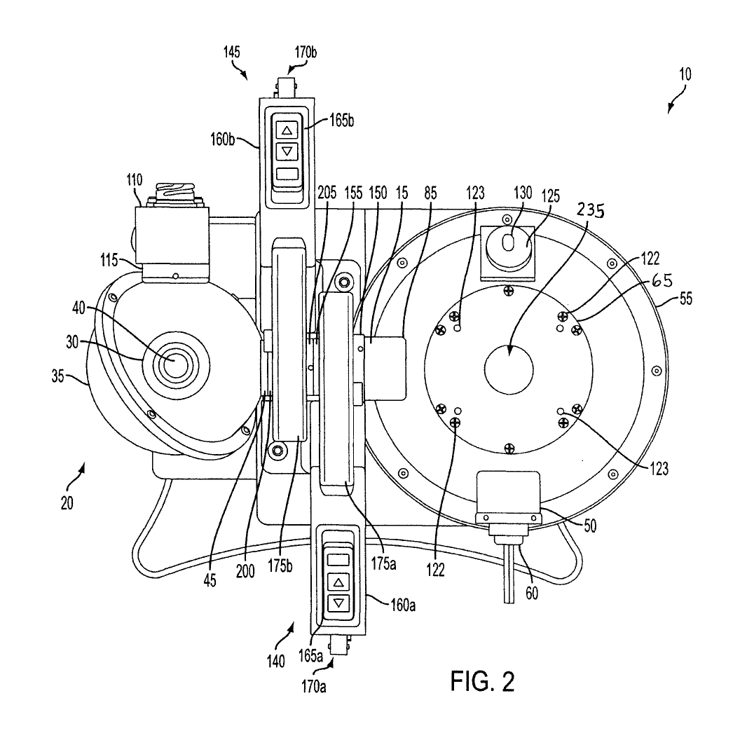

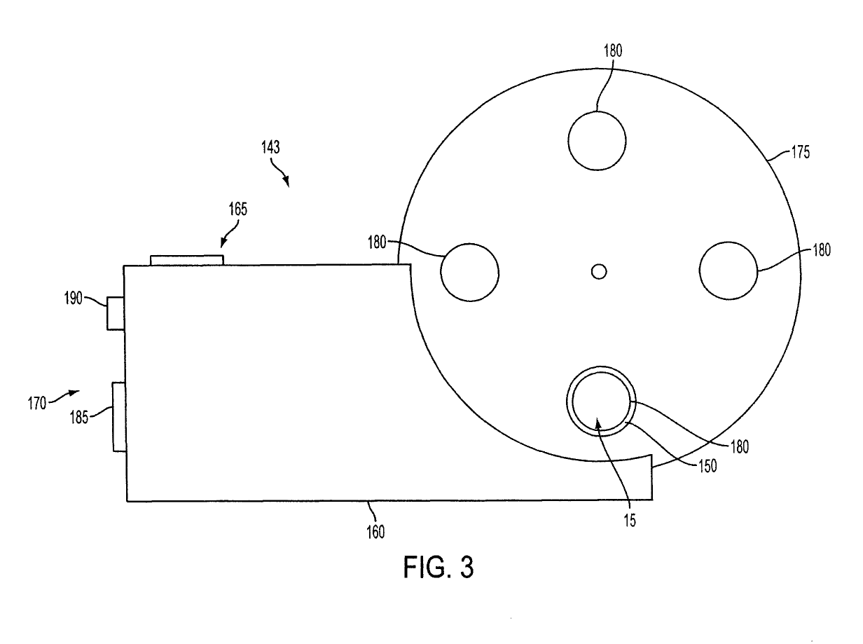

Referring now to FIG. 1, a side elevation view of the sphere assembly 10 is shown. The sphere assembly 10 has a source integrating sphere 20 and a test integrating sphere 25 connected by an optical channel 15. The source integrating sphere 20 may have a source shell 35 that provides structure rigidity to the source integrating sphere 20. The source integrating sphere 20 may have a source frame port 45 coupled to the source shell 35 defining a source frame aperture (not shown) that optically links the source integrating sphere 20 to the rest of the sphere assembly 10. The source integrating sphere 20 may also have an auxiliary port 30 defining an auxiliary port aperture (not shown) coupled to the source shell 35. An auxiliary adaptor 40 may be coupled to the auxiliary port 30 and extends in an outward direction relative to the center of the source integrating sphere 20. In one embodiment, the auxiliary adaptor 40 may be configured to accept the liquid light guide cable from an OL490 Agile Light Source, available from Optronics Laboratories, a Gooch & Housego Company or a secondary source of electromagnetic radiation. However, it should be understood that in other embodiments the auxiliary adaptor 40 may be configured to accept a liquid light guide cable from an auxiliary light source (not shown). In still other embodiments, the auxiliary light source may be mounted directly to the auxiliary port 30, rendering the auxiliary adaptor 40 unnecessary. In yet another embodiment, a second spectrometer probe (not shown) may be coupled to the auxiliary port 30 to measure the spectral distribution of the source 110 (FIG. 2) and compare those measurements to the spectral distribution from the test integrating sphere 25. This may be advantageous to calibrate a plurality of filters 180 (FIG. 3).

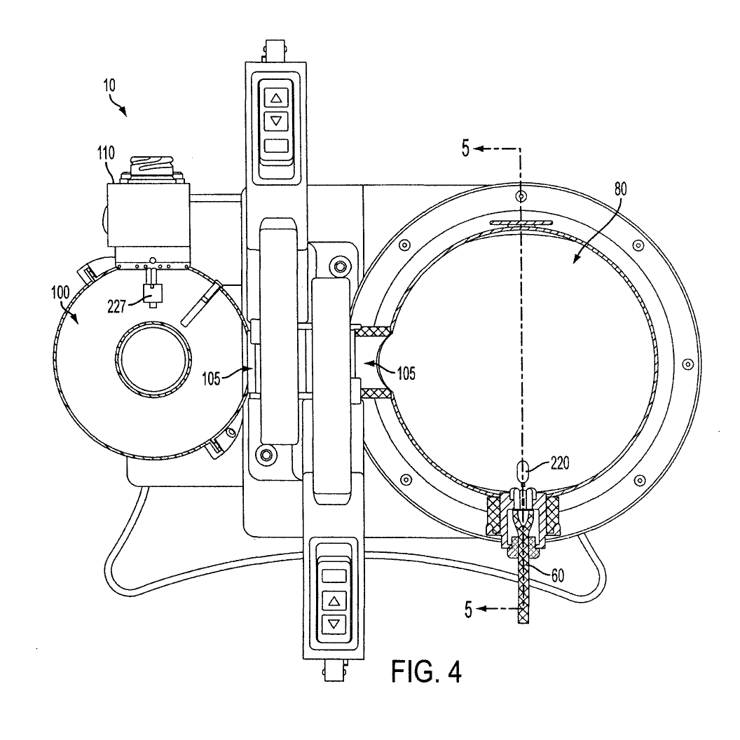

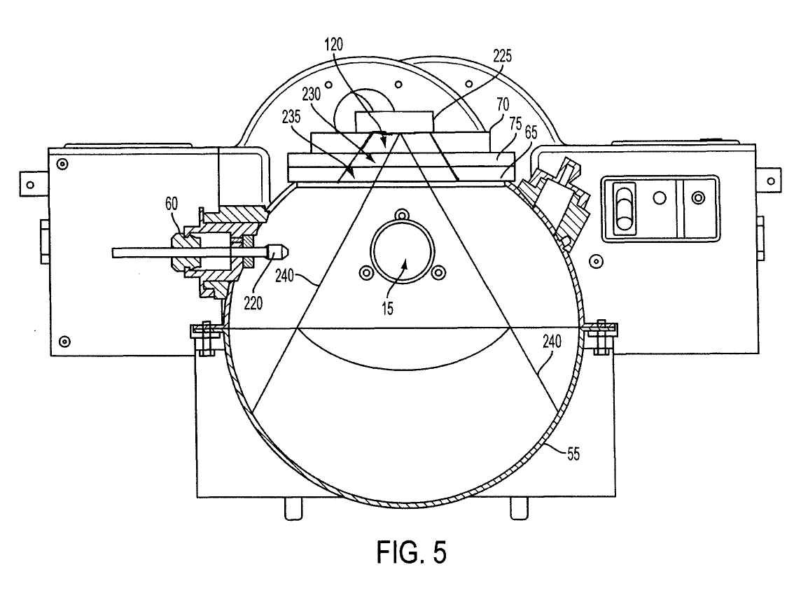

The test integrating sphere 25 may have a test shell 55 that provides structure rigidity to the test integrating sphere 25. The test integrating sphere 25 may have a calibration port 50 coupled to a test shell 55 defining a calibration aperture (not shown). A calibration light source 60 may be coupled to the calibration port 50 and may be exposed to a test interior 80 (FIG. 4) of the test integrating sphere 25 through the calibration aperture. In one embodiment, the calibration light source 60 may be an OGL-050, 5 W calibration lamp calibrated for 2π spectral flux from LabSphere®. In another embodiment, the calibration source may be an electromagnetic radiation source of a specific band of wavelengths or an electromagnetic radiation source that allows adjustment of the range of the specific band of wavelengths. The test shell 55 may have a test frame port 85 defining a test frame aperture (not shown) that optically links the test integrating sphere 25 to the rest of the sphere assembly 10. Three plates may be used to secure a device 225 (FIG. 5) to the test integrating sphere 25. A mount plate 65 may be coupled to the test shell 55 and define a mount aperture 235 (FIG. 5). A fixture plate 70 may be coupled to the mount plate 65 and define a test aperture 120 (FIG. 2). An adaptor plate 75 may be coupled between the fixture plate 70 and the mount plate 65; the adaptor plate 75 defining an adaptor aperture 230 (FIG. 5). The device 225 to be tested may have a camera and may be coupled to the fixture plate 70. The camera may be aligned with the test aperture 120, adaptor aperture 230, if used, and the mount aperture 235. The camera will be exposed to any light within the test interior 80 of the test integrating sphere 25 through the mount aperture 235, test aperture 120, and the adaptor aperture 230, if used.

Referring to FIGS. 2 and FIG. 5, the fixture plate 70 may be coupled to the device 255 as the device 255 is tested at various testing stations (not shown). The mount plate 65 may include a plurality of mounting points 122. The mounting points 122 may be a plurality of holes (not shown) for posts or pins (not shown) for the fixture plate 70 to couple with. The mounting points 122 may be a plurality of threaded holes to permit the fixture plate 70 to be secured to the mount plate 65 with fastening means, including screws and the like. A plurality of locator pins 123 may be used to ensure the proper position of the camera of the device 225 and fixture plate 70 over the mount aperture 235. In other embodiments, the mount plate 65 may not include mounting points 122. For example, in one embodiment, the fixture plate 70 may be secured to a portion of the test integrating sphere 25 using an adhesive.

Referring back to FIG. 1, the source shell 35 and the test shell 55 are coupled to a base plate 90 with brackets 95. The brackets 95 may secure the test integrating sphere 25 and the source integrating sphere 20 to align the test frame aperture and the source frame aperture defining the optical channel 15 between them. The optical channel 15 allows electromagnetic radiation to pass between the test integrating sphere 25 and the source integrating sphere 20. The source integrating sphere 20 and the test integrating sphere 25 may have any diameter required to achieve the desired illumination of the device. In some embodiments, the source integration sphere may be from about 50.8 mm (2 inches) to about 203.2 mm (8 inches), preferably about 101.6 mm (4 inches) and the test integration sphere may be from about 101.6 mm (4 inches) to about 254 mm (10 inches), preferably about 152.4 mm (6 inches).

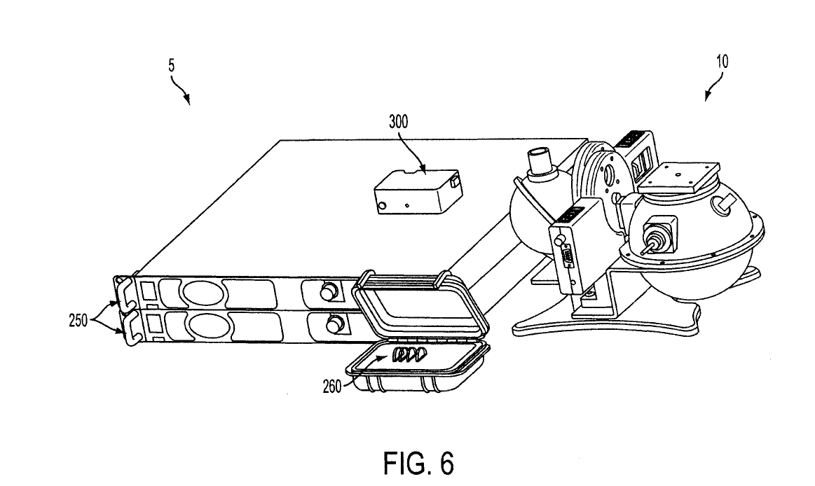

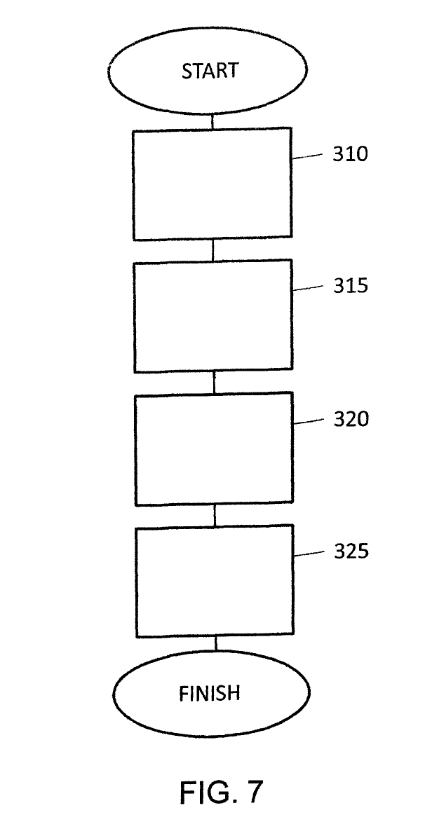

FIG. 2 depicts a top view of the sphere assembly 10. A source port 115 coupled to the source shell 35 defines a source aperture (not shown). The source 110 may be coupled to the source port 115 and illuminate the source interior 100 (FIG. 4) through the source aperture. For example, the source 110 may be a tungsten halogen lamp or it may be a stabilized LED source and the examples should not be construed as limited as any sufficient source that produces electromagnetic radiation may be used. A first test port 125 defining a first test aperture (not shown) may be coupled to the test shell 55 of the test integrating sphere 25. In some embodiments, the first test port may be a spectrometer port 125 defining a spectrometer aperture (not shown). A spectrometer probe 130 may be coupled to the spectrometer port and be exposed to the light within the test interior 80 through the spectrometer aperture. An example of the spectrometer probe 130 may be a fiber optic cable operable to carry the light within sphere assembly 10 to the spectrometer 300 (FIG. 6) or a spectrometer detector that measures the spectrum of the light within the test integrating sphere 25 and electrically signals the results to the spectrometer for display.

Referring to FIGS. 1 and 2, the source integrating sphere 20 and the test integration sphere may have a reflective coating on the test interior 80, a source interior 100, and the optical channel interior 105 as shown in FIG. 4. In some embodiments, the test interior 80, source interior 100, and the optical channel interior 105 may use a highly reflective coating such as, for example, barium sulfate coating to achieve a highly reflective value. One example of a barium sulfate coating includes, but is not limited to a Spectraflect® coating available from LabSphere®. Light from a source 110 illuminates the source integrating sphere 20. The light is diffusely reflected in all directions within the source interior 100 until the source integrating sphere 20 is uniformly illuminated by the light at all points within the source shell 35. The optical channel 15 allows the light from the source integrating sphere 20 to illuminate the test integrating sphere 25. Light is diffused in all directions within the test interior 80 until the test integrating sphere 25 is uniformly illuminated by the light at all points within the test shell 55. It should be understood that the location of the source aperture (not shown), auxiliary aperture (not shown), source frame aperture (not shown), test frame aperture (not shown), first test aperture (not shown) or spectrometer aperture (not shown), calibration aperture not shown), and the mount aperture 235 (FIG. 5) as shown in the figures may be placed anywhere on their respective shells (source shell 35 or test shell 55) and are not limited to the locations as shown in FIGS. 1 and 2.

Referring to FIG. 3, an illustrative filter assembly 143 is shown. One or more filter assemblies (e.g., filter assembly 143) may be included in the sphere assembly and/or the test system. The filter assembly 143 may have a filter frame 160 coupled to a manual control pad 165, a plurality of communication connectors 170 (e.g., 190 and 185), and a wheel 175. Examples of communication connectors 170 may be a RS-232 connector 185, BNC connector 190, optical fiber connector, coax connectors, a universal serial bus (USB) connector, and any combination thereof. A plurality of filters 180 may be coupled to the wheel 175 along an outer circumference of the wheel. Each filter 180 may be different from the other filters 180 on the wheel 175 and each may alter the optical properties of the electromagnetic radiation passing through it. Each filter 180, when the wheel 175 is rotated, may align with the optical channel 15 as defined by the inner circumference of the sphere port 150. Each filter 180 may either attenuate or spectrally alter the electromagnetic radiation that passes through it. The embodiment depicted in the figures includes two filter wheels: 175a and 175b. The first wheel 175a may comprise a clear filter, a block filter, an 80A filter, an 81EF filter, an 81A filter, and a Coral 10 filter. The second wheel 175b may comprise a clear filter, a 625 nm longpass filter, a 650 nm longpass filter, a 675 nm longpass filter, a 570 nm bandpass filter with a 10 nm bandwidth, and a 540 nm bandpass filter with a 10 nm bandwidth. It should be understood that the specific filters in each wheel 175a, 175b are not limited to the filters 180 set forth above.

Referring back to FIG. 1, a first filter assembly 140 and a second filter assembly 145 are shown in FIGS. 1 and 2 but the disclosure is not limited to only two filter assemblies. Furthermore, in some embodiments, the sphere assembly 10 may have only one filter assembly or none at all. The first filter assembly 140 may have a first filter frame 160a coupled to a first manual control pad 165a, a plurality of first communication connectors 170a, and a first wheel 175a. A plurality of first filters may be coupled to the first wheel 175a along an outer circumference of the first wheel 175a where each first filter will align with the optical channel 15 when the first wheel 175a is rotated by a motor assembly. The first filter assembly 140 may have a sphere port 150 and a connector port 155 which may allow the first filter assembly 140 to couple with the source integrating sphere 20 and the test integrating sphere 25. The sphere port 150 defines a sphere port aperture (not shown) and the connector port 155 defines a connector port aperture (not shown). The optical channel 15 may be defined by the alignment of the source frame aperture (not shown), the connector port aperture (not shown), the sphere port aperture (not shown), and the test frame aperture (not shown). For example, the optical channel 15 aperture alignment may be defined by the sphere port 150 coupled with the source frame port 45 and the connector port 155 coupled with the test frame port 85. The alignment of the optical channel 15 is held by a plurality of adaptors, or collars, coupled between the sphere port 150 and the source frame port 45, and the connector port 155 and the test frame port 85.

In another embodiment, the second filter assembly 145 may be coupled to the sphere assembly 10. For example, the second filter assembly 145 may couple with the source integrating sphere 20 and the first filter assembly 140. The second filter assembly 145 may have a second filter frame 160b coupled to a second manual control pad 165b, a plurality of second communication connectors 170b, and a wheel 175b. A plurality of secondary filters may be coupled to the wheel 175b along an outer circumference of the wheel 175b where each secondary filter will align with the optical channel 15 when the wheel 175b is rotated by a motor assembly. The second filter assembly 145 may have a second sphere port 200 and a second connector port 205 which may allow the second filter assembly 145 to couple with the source integrating sphere 20 and the test integrating sphere 25. The second sphere port 200 defines a second sphere port aperture (not shown) and the second connector port 205 defines a second connector port aperture (not shown). The optical channel 15 may be defined by the alignment of the source frame aperture (not shown) the connector port aperture (not shown), the second connector port aperture (not shown), the sphere port aperture (not shown), the second sphere port aperture (not shown), and the test frame aperture (not shown). For example, the optical channel 15 aperture alignment may be defined by the second sphere port 200 aligned with the source frame port 45, the connector port 155 aligned with the second connector port 205, and the sphere port 150 aligned with the test frame port 85. The alignment of the optical channel 15 is held by a plurality of adaptors, or collars, coupled between the second connector port 205 and the connector port 155, the second sphere port 200 and the source frame port 45, and the sphere port 150 and the test frame port 85.

In some embodiments, the plurality of filters 180 may allow only a percentage of light to pass through the optical channel 15 and range from no filter which may allow 100% of the light from the source integrating sphere 20 to pass through the optical channel 15 into the test integrating sphere 25, to an opaque filter which may allow 0% of the light from the source integrating sphere 20 to pass through the optical channel 15 into the test integrating sphere 25. In another embodiment, the plurality of filters 180 may be polarization filters which may only allow polarized light to pass from the optical channel 15 into the test integrating sphere 25 or band pass filters which may allow only a certain wavelength of light from the electromagnetic spectrum to pass from the optical channel 15 into the test integrating sphere 25.

The first wheel 175a of the first filter assembly 140 may be rotated either physically by hand or electro-mechanically via a motor assembly (not shown). A command signal is given to the motor assembly of the first filter assembly 140 to rotate the first wheel 175a. The command signal may be given by a computer electrically coupled to the plurality of first communication connectors 170a or through selection and pressing of one of a plurality of buttons on the first manual control pad 165a. Once the command signal is given, the first wheel 175a will change a current filter located in the optical channel 15 to another filter chosen from the plurality of filters 180.

The second wheel 175b of the second filter assembly 145 may be rotated either physically by hand or electro-mechanically via a motor assembly (not shown). The second wheel 175b of the second filter assembly 145 aligns one of the plurality of secondary filters with the optical channel 15 and when a second command signal is sent to the second filter assembly 145, the second wheel 175b, rotates to change the secondary filter in the optical channel 15. The command signal may be given by a computer electrically coupled to the plurality of second communication connectors 170b or through selection and pressing of one of a plurality of second buttons on the second manual control pad 165b. Once the second command signal is given, the second wheel 175b will change a current secondary filter located in the optical channel 15 to another secondary filter chosen from the plurality of secondary filters. FIGS. 1 and 2 depict the second filter assembly 145, 180 degrees out of phase with the first filter assembly 140. It should be understood that the disclosure is not limited to the 180 degree out of phase orientation as depicted and the second filter assembly 145 may be oriented the same direction as the first filter assembly 140.

FIG. 4 depicts a cross-sectional view of the sphere assembly 10 from FIG. 1. The test interior 80 and the source interior 100 are coupled by the optical channel interior 105. The test interior 80 and the source interior 100 are spherical in shape except where punctuated by an aperture as described above. The calibration light source 60 has a calibration illumination dome 220 within the test interior 80 which may allow the electromagnetic radiation from the calibration light source 60 to completely illuminate the test interior 80. The source 110 has a source illumination dome 227 within the source interior 100 which may allow the electromagnetic radiation from the source 110 to completely illuminate the source interior 100.

FIG. 5 depicts a cross-sectional view of the test integrating sphere 25 from FIG. 4. The calibration light source 60/calibration illumination dome 220 and the optical channel 15 are shown in the upper hemisphere of the test integrating sphere 25. It should be understood that the calibration light source 60 and optical channel 15 are not limited to the upper hemisphere and may be placed anywhere on the test shell 55. The stacking of the mount plate 65, the adaptor plate 75 and the fixture plate 70 are shown. The associated apertures (120, 230, and 235) are also shown. The smallest aperture is the test aperture 120 which may be in a conical shape with the smallest circumference of the cone terminating at the device 225 to be tested. The adaptor aperture 230 and the mount aperture 235 are conical in shape and match the slope of the test aperture 120. It should be understood that the shape of the test aperture 120, adaptor aperture 230, and the mount aperture 235 are not limited to a conical shape but may be of any shape that does not interfere with the field of view 240 of the device 225. For example the field of view may be less than about 70 degrees, or about 70 degrees to about 80 degrees, or about 80 degrees to about 90 degrees. Furthermore, the test aperture 120, adaptor aperture 230, and the mount aperture 235 may be coated with a reflective coating to match the reflective coating of the test integrating sphere 25.

FIG. 6 depicts a mobile device camera testing system 5. The mobile device camera testing system 5 generally comprises one or more programmable power supplies 250, a spectrometer 300, and a sphere assembly 10. The spectrometer 300 may be optically coupled to the spectrometer probe 130 (FIG. 2) as described above or the spectrometer 300 may be coupled to the sphere assembly 10 without the need for a spectrometer probe 130. The spectrometer 300 may be a charge coupled device (“CCD”) grating spectrometer that permits light from the sphere assembly 10 to be analyzed. The spectrometer 300 may be powered via a USB connection to a computer (not shown). In one embodiment, the spectrometer 300 is a thermoelectric-cooled CCD grating spectrometer. In such an embodiment, the thermoelectric-cooled CCD grating spectrometer may receive power via a USB connection to a computer and/or from a separate, dedicated DC power supply. While a CCD grating spectrometer or a thermoelectric-cooled CCD spectrometer may be used in the mobile device camera testing system 5, it should be understood that other spectrometers may be used in other embodiments of the mobile device camera testing system 5.

In some embodiments, each programmable power supply 250 may be a constant current DC power supply that provides power to light sources in the sphere assembly 10 via power cables (not shown). While the embodiment depicted in FIG. 6 includes two programmable power supplies 250, other embodiments may contain only one programmable power supply 250 or more than two programmable power supplies 250.

Referring now to FIGS. 1 through 6, in operation, the mobile device camera testing system 5 provides a substantially uniform illumination to cameras contained within mobile devices 225 during testing. The mobile device camera testing system 5 may provide a maximum, unfiltered luminance level that is roughly equivalent to the luminance of about an 18% Lambertian reflective target illuminated by a 1000 lux light source, which is substantially equivalent to a luminance of approximately 60 cd/m³. However, it will be appreciated that the particular luminance level provided by the mobile device camera testing system 5 will depend on the particular application for which it is used.

The programmable power supply 250 supplies power to the source 110, which inputs electromagnetic radiation into the source integrating sphere 20 through the source port 115. The desired filter 180 to be placed in the optical channel 15 between the source integrating sphere 20 and the test integrating sphere 25 may be selected from the one or more wheels 175 by manually selecting the appropriate filter 180 (if the wheel 175 is manual) or by automatically selecting the appropriate filter 180 (if the wheel 175 is automatic via a computer). The selection of the desired filter 180 determines the luminance and spectral content of the light or electromagnetic radiation that enters the test integrating sphere 25 from the source integrating sphere 20. It should be understood that the desired filter 180 may also include selection of the secondary filter 180b if the second filter assembly 145 is used.

Referring to FIGS. 1-7, to test the camera, the mobile device 225 containing the camera is secured 310 to the fixture plate 70 of the test integrating sphere 25 such that the camera is aligned with the test aperture 120 of the fixture plate 70 and receives light from the test integrating sphere 25. The source 110 is illuminated and the proper filter 180 or filters (filter 180a and/or secondary filter 180b) are in place, the test integrating sphere 25 is illuminated 315 with electrometric radiation. An image capturing 320 a spectral distribution of the illumination 315 entering the camera lens from the test integrating sphere 25 may then be acquired from the camera. At the same time, the spectrometer 300 measures the spectral content of the illumination of the light in the test integrating sphere 25. The spectral distribution of an image acquired by the camera may then be processed, evaluated and compared 325 of the spectral measurement from the spectrometer 300 using a computer. The spectral measurement is the characteristics of the electromagnetic radiation measured by the spectrometer 300 to include the luminance and color of the light in the test integrating sphere 25. This process may optionally be repeated for each filter 180 and/or secondary filter 180b of the one or more wheels 175. Once testing of the camera of the mobile device under test is complete, the system may be powered down and mobile device under test may be removed from the fixture plate.

The mobile device camera testing system 5 may also be used to test an light emitting diode (LED) (not shown) associated with a mobile device 225 under test. In order to test the LED, the wheel 175 may be set to a closed position or set to a filter 180 that 100% opaque such that no light from the source integrating sphere 20 enters the test integrating sphere 25. The LED may then be illuminated, illuminating the test integrating sphere 25 with electromagnetic radiation. The electromagnetic radiation may be from the visible spectrum, i.e. light. The light output by the LED is then projected into the test integrating sphere 25 and subsequently sensed and measured by the spectrometer 300. The output of spectral measurement from the spectrometer 300 is then used to calculate color parameters for the LED. The spectral measurement is then compared, using a computer, to the spectral distribution captured by the camera to determine if the spectral response of the camera and/or the spectral distribution of electromagnetic radiation from the LED meet requirements.

The calibration light source 60 may be used to periodically recalibrate the response of the spectrometer 300. In order to recalibrate the spectrometer 300, the wheel 175 may be set to a closed position or set to a filter 180 that 100% opaque such that no light from the source integrating sphere 20 enters the test integrating sphere 25. Then, the calibration light source 60 may be illuminated. The calibration light source 60 outputs light of a known luminance, from which the response of the spectrometer 300 may be calibrated. A spectral scan is then acquired from the spectrometer 300. The acquired spectral scan from the spectrometer 300 in conjunction with the known luminance and spectral content output by the calibration light source 60 may then be used to generate new calibration curves for the spectrometer 300.

While the embodiments described herein are directed to the testing of cameras and/or LEDs included in mobile devices 225, the present disclosure may also be utilized to test stand-alone cameras, cameras incorporated in any other type of device, or LEDs in such cameras or devices.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

Certain terminology is used in the disclosure for convenience only and is not limiting. The words “left”, “right”, “front”, “back”, “upper”, and “lower” designate directions in the drawings to which reference is made. The terminology includes the words noted above as well as derivatives thereof and words of similar import.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A sphere assembly comprising:
a source integrating sphere comprising:
a source shell,
a source port coupled to the source shell,
a source coupled to the source port, and
a source frame port coupled to the source shell;
a test integrating sphere with a test shell comprising:
a mount plate coupled to the test shell,
a first test port coupled to the test shell, and
a test frame port coupled to the test shell; and
a first filter assembly comprising:
a first filter frame,
an optical channel between the source integrating sphere and the test integrating sphere comprising:
a sphere port coupled to the first filter frame and aligned with the source frame port, and
a connector port coupled to the first filter frame and aligned with the test frame port,
a first communication connector coupled to the first filter frame,
a first manual control pad coupled to the first filter frame, and
a first wheel coupled to the first filter frame and comprising a plurality of first filters, the first wheel aligns one of the plurality of first filters with the optical channel, wherein when a command signal is sent to the first filter assembly, the first wheel, rotates to change the first filter in the optical channel.

2. The sphere assembly of claim 1, wherein the first manual control pad comprises a plurality of buttons, and wherein the command signal is sent by pressing one of the plurality of buttons.

3. The sphere assembly of claim 1, wherein the command signal is sent by a computer electrically coupled to the first communication connector.

4. The sphere assembly of claim 3, wherein the first communication connector is selected from the group of first communication connectors consisting of a RS-232 connector, a BNC connector, a fiber connector, a universal serial bus connector, a coax connector, and any combination thereof.

5. The sphere assembly of claim 1, wherein the alignment of the optical channel is held by a plurality of adaptors coupled between the sphere port and the source frame port, and the connector port and the test frame port.

6. The sphere assembly of claim 1, further comprising an adaptor plate coupled between the mount plate and a fixture plate.

7. The sphere assembly of claim 1, further comprising a second filter assembly comprising:
a second filter frame;
the optical channel between the source integrating sphere and the test integrating sphere comprising:
a second connector port coupled to the second filter frame and aligned with the connector port,
a second sphere port coupled to the second filter frame and aligned with the source frame port, and
the sphere port aligned with the test frame port;
a second communication connector coupled to the second filter frame;
a second manual control pad coupled to the second filter frame; and
a second wheel coupled to the second filter frame and comprising a plurality of secondary filters, the second wheel aligns one of the plurality of secondary filters with the optical channel, wherein when a second command signal is sent to the second filter assembly, the second wheel, rotates to change the secondary filter in the optical channel.

8. The sphere assembly of claim 7, wherein the alignment of the optical channel is held by a plurality of adaptors coupled between the second connector port and the connector port, the second sphere port and the source frame port, and the sphere port and the test frame port.

9. The sphere assembly of claim 1 further comprising:
a calibration port coupled to the test shell; and
a calibration light source coupled to the calibration port.

10. The sphere assembly of claim 1, further comprising an auxiliary port coupled to the source shell.

11. The sphere assembly of claim 1, wherein the first test port is a spectrometer port and further comprising a spectrometer probe and a spectrometer, the spectrometer probe coupled to the spectrometer port and the spectrometer optically coupled to the spectrometer probe.

12. The sphere assembly of claim 1, further comprising a programmable power supply which supplies power to the source.

13. (canceled)

14. The method of claim 21, further comprising:
receiving the command signal from the manual control pad to rotate the first wheel; and
filtering the electromagnetic radiation in the optical channel.

15. The method of claim 21, further comprising:
receiving the command signal to rotate the first wheel from a computer electrically coupled to the first communication connector; and
filtering the electromagnetic radiation in the optical channel.

16. The method of claim 21, further comprising:
illuminating the test integrating sphere with a known electromagnetic radiation from a calibration light source coupled to a calibration port coupled to the test shell; and
calibrating the spectrometer by adjusting the spectral distribution of the spectrometer to match a calibration spectral distribution of the calibration light source.

17. A method of testing a mobile device camera and light emitting diode assembly comprising:
securing a mobile device camera and light emitting diode assembly to a sphere assembly comprising:
a source integrating sphere comprising:
a source shell,
a source port coupled to the source shell,
a source coupled to the source port, and
a source frame port coupled to the source shell;
a test integrating sphere with a test shell comprising:
a mount plate coupled to the test shell,
a spectrometer port coupled to the test shell,
a spectrometer coupled to the spectrometer port, and
a test frame port coupled to the test shell; and
illuminating the test integration sphere with electromagnetic radiation from the light emitting diode;
capturing a spectral distribution of an image acquired by the mobile device camera; and
comparing the spectral distribution to a spectral measurement from the spectrometer.

18. A mobile device testing system to test a mobile device camera comprising:
a source integrating sphere comprising:
a source shell,
a source port coupled to the source shell,
a source coupled to the source port, and
a source frame port coupled to the source shell;
a test integrating sphere with a test shell comprising:
a mount plate coupled to the test shell,
an adaptor plate coupled to the mount plate,
a spectrometer port coupled to the test shell, and
a test frame port coupled to the test shell;
a first filter assembly comprising:
a first filter frame,
an optical channel between the source integrating sphere and the test integrating sphere comprising:
a sphere port coupled to the first filter frame and aligned with the source frame port, and
a connector port coupled to the first filter frame and aligned with the test frame port,
a first communication connector coupled to the first filter frame,
a first manual control pad coupled to the first filter frame, and
a first wheel coupled to the first filter frame and comprising a plurality of first filters, the first wheel aligns one of the plurality of first filters with the optical channel, wherein when a command signal is sent to the first filter assembly, the first wheel, rotates to change the first filter in the optical channel;
a second filter assembly comprising:
a second filter frame;
the optical channel between the source integrating sphere and the test integrating sphere comprising:
a second connector port coupled to the second filter frame and aligned with the connector port,
a second sphere port coupled to the second filter frame and aligned with the source frame port,
the sphere port aligned with the test frame port, and
wherein the alignment of the optical channel is held by a plurality of adaptors coupled between the second connector port and the connector port, the second sphere port and the source frame port, and the sphere port and the test frame port;
a second communication connector coupled to the second filter frame;
a second manual control pad coupled to the second filter frame; and
a second wheel coupled to the second filter frame and comprising a plurality of secondary filters, the second wheel aligns one of the plurality of secondary filters with the optical channel, wherein when a second command signal is sent to the second filter assembly, the second wheel, rotates to change the secondary filter in the optical channel;
a programmable power supply which supplies power to the source
a spectrometer probe coupled to the spectrometer port,
a spectrometer coupled to the spectrometer probe,
a calibration port coupled to the test shell; and
a calibration light source coupled to the calibration port.

19. The testing system of claim 18 wherein the first manual control pad comprises a plurality of buttons, and wherein the command signal is sent by pressing one of the plurality of buttons and the second manual control pad comprises a plurality of second buttons, and wherein the second command signal is sent by pressing one of the plurality of second buttons.

20. The testing system of claim 18, wherein the command signal is sent by a computer electrically coupled to the first communication connector and the second command signal is sent by the computer electrically coupled to the second communication connector.

21. The method of claim 17, wherein the sphere assembly further comprises a first filter assembly comprising:
a first filter frame;
an optical channel between the source integrating sphere and the test integrating sphere comprising:
a sphere port coupled to the first filter frame and aligned with the source frame port, and
a connector port coupled to the first filter frame and aligned with the test frame port;
a first communication connector coupled to the first filter frame;
a first manual control pad coupled to the first filter frame; and
a first wheel coupled to the first filter frame and comprising a plurality of first filters, the first wheel aligns one of the plurality of first filters with the optical channel, wherein when a command signal is sent to the first filter assembly, the first wheel, rotates to change the first filter in the optical channel.
